(19) United States
(12) Patent Application Publication
(10) Pub. No.: US 2026/0121919 A1
(43) Pub. Date: Apr. 30, 2026

(54) RESOLVING CONNECTION ISSUES USING A LARGE LANGUAGE MODEL

(71) Applicant: SAP SE, Walldorf (DE)

(72) Inventors: Qiu Shi Wang, Singapore (SG); Lin Cao, Singapore (SG)

(21) Appl. No.: 18/926,797

(22) Filed: Oct. 25, 2024

(51) Int. Cl. H04L 41/0813; H04L 41/08; H04L 41/0869; H04L 41/16

(52) U.S. Cl. CPC H04L 41/0813; H04L 41/0869; H04L 41/0886; H04L 41/16

(57) ABSTRACT

In an example embodiment, generative artificial intelligence (GAI) technology is used along with a retrieval-augmented generation approach to identify any network destination configuration information discrepancies or misconfigurations. More specifically, the domain knowledge of the cloud service provider where the network destination is configured, specifications of various backend services, and examples of network destination configurations are embedded using an embedding machine learning model and indexed in a vector database. The configuration information in the network destination defined by the user will be used to query the vector database to retrieve similar knowledge. The retrieved knowledge, together with the user's network destination definition, will be sent to the GAI model to identify the issue and provide a resolution.

### TECHNICAL FIELD

This document generally relates to computer systems. More specifically, this document relates to resolving connection issues using a large language model.

### BACKGROUND

In a computer system, software servers are often used to manage applications that interact with one or more software clients over a computer network, such as the Internet. An OData server is a type of web server that implements the Open Data Protocol (OData) to enable the creation and consumption of RESTful Application Program Interfaces (APIs) for data sources. OData is a protocol for creating and consuming data APIs that are consistent with RESTful principles and expose data as resources that can be accessed using standard HyperText Transfer Protocol (HTTP) methods like GET, POST, PUT, PATCH and DELETE.

An OData server allows developers to expose data from various sources such as databases, file systems, or web services as OData feeds, which can be consumed by client applications. The OData server maps the HTTP requests to the corresponding data operations and returns the data in a standardized format, typically JavaScript Object Notation (JSON) or Extensible Markup Language (XML). OData servers are used in various contexts, such as enterprise data integration, business intelligence, and mobile application development. They enable the creation of scalable and flexible APIs that can be consumed by a wide range of clients, including web and mobile applications, desktop software, and other backend systems.

### BRIEF DESCRIPTION OF THE DRAWINGS

The present disclosure is illustrated by way of example and not limitation in the figures of the accompanying drawings, in which like references indicate similar elements.

FIG. 1 is a block diagram illustrating a system for resolving connection issues, in accordance with an example embodiment.

FIG. 2 is a screen capture illustrating a user interface screen where a user can enter an OData configuration for an OData destination, in accordance with an example embodiment.

FIG. 3 is a screen capture illustrating a screen of a user interface where a user can accept recommendations from an LLM, in accordance with an example embodiment.

FIG. 4 is a flow diagram illustrating a method for resolving connection issues, in accordance with an example embodiment.

FIG. 5 is a block diagram illustrating a software architecture, in accordance with an example embodiment.

FIG. 6 illustrates a diagrammatic representation of a machine in the form of a computer system within which a set of instructions may be executed for causing the machine to perform any one or more of the methodologies discussed herein.

### DETAILED DESCRIPTION

The description that follows discusses illustrative systems, methods, techniques, instruction sequences, and computing machine program products. In the following description, for purposes of explanation, numerous specific details are set forth to provide an understanding of various example embodiments of the present subject matter. It will be evident, however, to those skilled in the art, that various example embodiments of the present subject matter may be practiced without these specific details.

Many users face issues when attempting to access OData destinations, and detecting the root cause can be quite challenging due to various factors. The issues encountered can stem from the security configuration of the cloud environment, different backend systems, functional limitations of the service provider, or simple typographical errors.

To address these issues, users typically report an issue in the form of a ticket that is sent to the cloud service provider for additional investigation and resolution. This overall process consumes a lot of resources.

In an example embodiment, generative artificial intelligence (GAI) technology is used along with a retrieval-augmented generation approach to identify any OData discrepancies or misconfigurations. More specifically, the domain knowledge of the cloud service provider where the OData destination is configured, specifications of various backend services, and examples of OData destination configurations are embedded using an embedding machine learning model and indexed in a vector database. The configuration information in the OData destination defined by the user will be used to query the vector database to retrieve similar knowledge. The retrieved knowledge, together with the user's OData destination definition, will be sent to the GAI model to identify the issue and provide a resolution.

“OData,” as used herein, may refer specifically to the Open Data Protocol, an open web protocol for querying and communicating data using Representational State Transfer (REST) web services, but could also apply to other types of web services. OData enables the creation and use of HTTP-based data services, which allow resources identified using Uniform Resource Identifiers (URIs) and defined in an abstract data model, to be published and edited by Web clients using simple HTTP messages. OData typically uses commonly deployed web technologies such as Transmission Control Protocol (TCP), HTTP, Atom Publishing Protocol, XML, and JSON to exchange data between systems. The results of OData queries (payloads) are typically structured in readily parsable formats, such as Atom, JSON, or XML, and may be parsed by any number of client libraries provided by platforms such as .NET, Silverlight, Java, AJAX, PHP, and mobile development platforms. OData, as used herein, may refer to any standardized or non-standardized version of the OData protocol, or like web protocols (e.g., Google Data Protocol (GData)) communicating using REST-based web service communication techniques.

A large language model (LLM) refers to an artificial intelligence (AI) system that has been trained on an extensive dataset to understand and generate human language. These models are designed to process and comprehend natural language in a way that allows them to answer questions, engage in conversations, generate text, and perform various language-related tasks.

LLMs used to generate information are generally referred to as Generative Artificial Intelligence (GAI) models. A GAI model may be implemented as a generative pre-trained transformer (GPT) model or a bidirectional encoder. A GPT model is a type of machine learning model that uses a transformer architecture, which is a type of deep neural network that excels at processing sequential data, such as natural language.

A bidirectional encoder is a type of neural network architecture in which the input sequence is processed in two directions: forward and backward. The forward direction starts at the beginning of the sequence and processes the input one token at a time, while the backward direction starts at the end of the sequence and processes the input in reverse order.

By processing the input sequence in both directions, bidirectional encoders can capture more contextual information and dependencies between words, leading to better performance.

The bidirectional encoder may be implemented as a Bidirectional Long Short-Term Memory (BILSTM) or BERT (Bidirectional Encoder Representations from Transformers) model.

Each direction has its own hidden state, and the final output is a combination of the two hidden states.

Long Short-Term Memories (LSTMs) are a type of recurrent neural network (RNN) that are designed to overcome the vanishing gradient problem in traditional RNNs, which can make it difficult to learn long-term dependencies in sequential data.

LSTMs include a cell state, which serves as a memory that stores information over time. The cell state is controlled by three gates: the input gate, the forget gate, and the output gate. The input gate determines how much new information is added to the cell state, while the forget gate decides how much old information is discarded. The output gate determines how much of the cell state is used to compute the output. Each gate is controlled by a sigmoid activation function, which outputs a value between 0 and 1 that determines the amount of information that passes through the gate.

In BiLSTM, there is a separate LSTM for the forward direction and the backward direction. At each time step, the forward and backward LSTM cells receive the current input token and the hidden state from the previous time step. The forward LSTM processes the input tokens from left to right, while the backward LSTM processes them from right to left.

The output of each LSTM cell at each time step is a combination of the input token and the previous hidden state, which allows the model to capture both short-term and long-term dependencies between the input tokens.

BERT applies bidirectional training of a model known as a transformer to language modelling. This is in contrast to prior art solutions that looked at a text sequence either from left to right or combined left to right and right to left. A bidirectionally trained language model has a deeper sense of language context and flow than single-direction language models.

More specifically, the transformer encoder reads the entire sequence of information at once, and thus is considered to be bidirectional (although one could argue that it is, in reality, non-directional). This characteristic allows the model to learn the context of a piece of information based on all of its surroundings.

In other example embodiments, a generative adversarial network (GAN) embodiment may be used. GAN is a supervised machine learning model that has two sub-models: a generator model that is trained to generate new examples, and a discriminator model that tries to classify examples as either real or generated. The two models are trained together in an adversarial manner (using a zero sum game according to game theory), until the discriminator model is fooled roughly half the time, which means that the generator model is generating plausible examples.

The generator model takes a fixed-length random vector as input and generates a sample in the domain in question. The vector is drawn randomly from a Gaussian distribution, and the vector is used to seed the generative process. After training, points in this multidimensional vector space will correspond to points in the problem domain, forming a compressed representation of the data distribution. This vector space is referred to as a latent space, or a vector space comprised of latent variables. Latent variables, or hidden variables, are those variables that are important for a domain but are not directly observable.

The discriminator model takes an example from the domain as input (real or generated) and predicts a binary class label of real or fake (generated).

Generative modeling is an unsupervised learning problem, although a clever property of the GAN architecture is that the training of the generative model is framed as a supervised learning problem.

The two models, the generator and discriminator, are trained together. The generator generates a batch of samples, and these, along with real examples from the domain, are provided to the discriminator and classified as real or fake.

The discriminator is then updated to get better at discriminating real and fake samples in the next round, and importantly, the generator is updated based on how well, or not, the generated samples fooled the discriminator.

In another example embodiment, the GAI model is a Variational AutoEncoders (VAEs) model. VAEs comprise an encoder network that compresses the input data into a lower-dimensional representation, called a latent code, and a decoder network that generates new data from the latent code. In either case, the GAI model contains a generative classifier, which can be implemented as, for example, a naïve Bayes classifier. The present solution works with any type of GAI model.

In an example embodiment, the transformer architecture includes a multi-head attention mechanism. Instead of using a single attention mechanism, multi-head attention employs several attention heads, each capable of learning to focus on different aspects of the input. This diversity helps the model capture a wider range of relationships within the data.

The process begins with the input, represented as a set of vectors. Each input vector is transformed into three different representations: queries, keys, and values, using learned weight matrices. For each attention head, scores are calculated by taking the dot product of the queries and keys. These scores are then scaled and passed through a softmax function to obtain attention weights, which are used to compute a weighted sum of the values.

After processing through all the heads, their outputs are concatenated and transformed by a linear layer, integrating the information gathered from different attention heads. This approach not only allows the model to learn complex relationships but also enables efficient parallel computation.

Ultimately, multi-head attention is typically followed by additional layers, such as feed-forward networks and layer normalization, creating a complete transformer block. This mechanism significantly enhances the model's ability to understand and generate text, making it effective for tasks like translation and summarization.

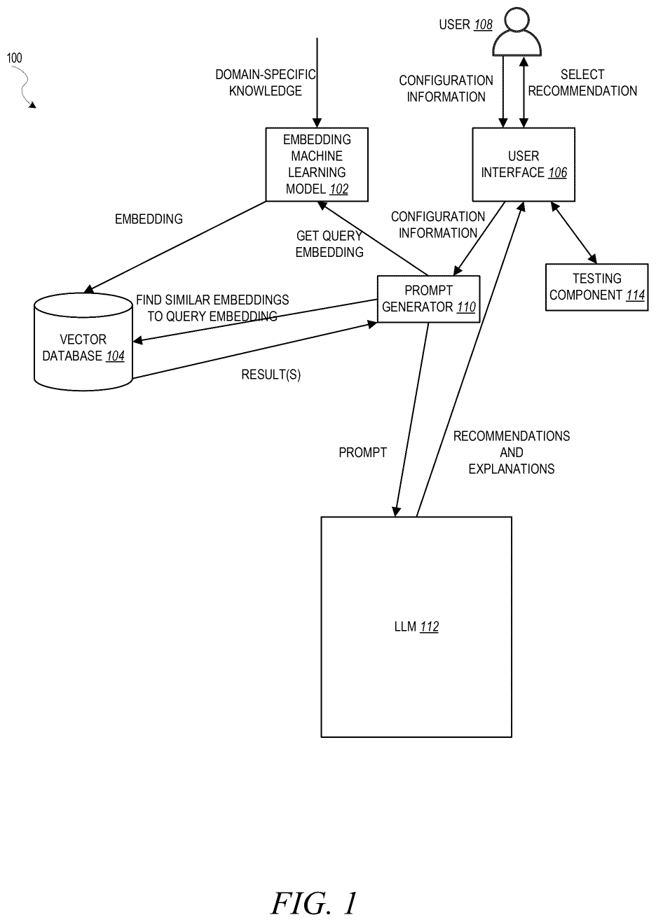

FIG. 1 is a block diagram illustrating a system 100 for resolving connection issues, in accordance with an example embodiment. Domain-specific knowledge of a cloud service provider, backend services, and examples of OData destination configurations are passed to an embedding machine learning model 102 that embeds this information into embeddings and stores the embeddings in a vector database 104. In an example embodiment, the vector database 104 can additionally contain dynamic content, specifically content from customer tickets that may be embedded and added to the vector database 104 as they are received and/or responded to. This dynamic content may also include, for example, log files.

An embedding is a set of coordinates in a latent n-dimensional space such that the proximity (e.g., cosine distance) of the coordinates to other coordinates is indicative of the similarity of the information embedded to those coordinates. In an example embodiment, the embedding is a high-dimensional (e.g., 1536-dimension) floating point vector and the texts with similar semantics will have the corresponding similar embeddings.

The embedding machine learning model 102 may be trained by any model from among many different potential supervised or unsupervised machine learning algorithms. Examples of supervised learning algorithms include artificial neural networks, Bayesian networks, instance-based learning, support vector machines, linear classifiers, quadratic classifiers, k-nearest neighbor, decision trees, and hidden Markov models.

In an example embodiment, the embedding machine learning algorithm used to train the embedding machine learning model 102 may iterate among various weights (which are the parameters) that will be multiplied by various input variables and evaluate a loss function at each iteration, until the loss function is minimized, at which stage the weights/parameters for that stage are learned. Specifically, the weights are multiplied by the input variables as part of a weighted sum operation, and the weighted sum operation is used by the loss function.

In some example embodiments, the training of the embedding machine learning model 102 may take place as a dedicated training phase. In other example embodiments, the embedding machine learning model may be retrained dynamically at runtime based on feedback.

In an example embodiment, the embedding machine learning model is part of a Large Language Model (LLM). LLMs provide for natural language processing (NPL) of text and rely on embeddings as part of its processing.

When a GAI model generates new, original data, it goes through the process of evaluating and classifying the data input to it. The product of this evaluation and classification is utilized to generate embeddings for data, which can then be later used to actually generate new data by the GAI model. In an example embodiment, however, the new, original data is either not generated or is irrelevant to the present solution. Rather, an embedding for the input piece of text is generated based on the intermediate work product of the GAI model that it would produce when going through the motions of generating the new, original data.

The result of an embedding process performed on a piece of data is an embedding, which is a vector. The vector may then be stored in a vector database 104.

A user interface 106 is provided to interact with a user 108, allowing the user 108 to define configuration information for their OData destination, review recommendations on how to modify the configuration information, confirm suggested changes, and further test the newly generated or modified OData destination configuration.

When the user interface 106 is used by the user 108 to define configuration information for their OData definition, the user interface 106 passes this configuration information to a prompt generator 110.

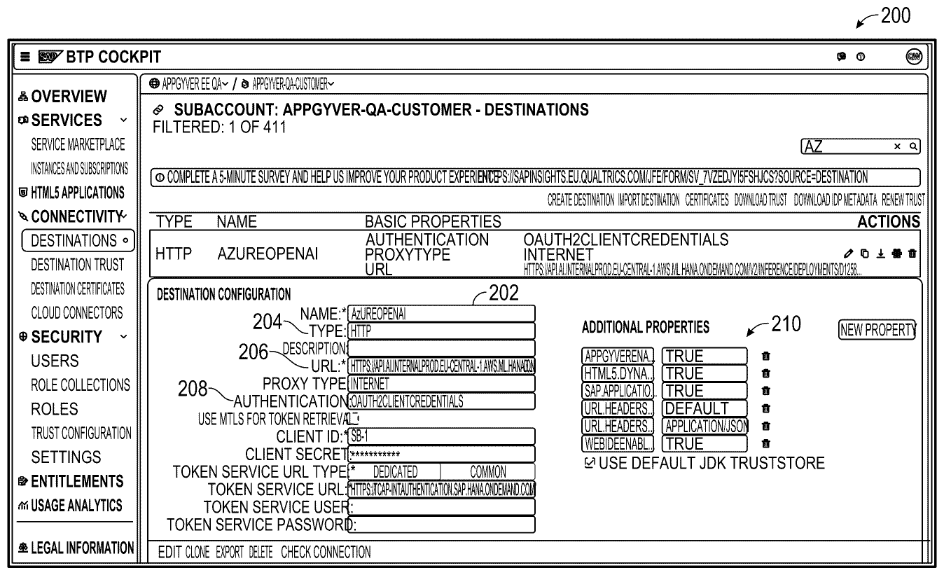

FIG. 2 is a screen capture illustrating a user interface screen 200 where a user can enter an OData configuration for an OData destination, in accordance with an example embodiment. Here, the user can specify parameters for the OData configuration, such as name 202, type 204, Uniform Resource Locator (URL) 206, authentication 208, etc., as well as additional custom properties 210.

Referring back to FIG. 1, the configuration information for an OData destination is then passed from the user interface 106 to the prompt generator 110 in the form of plain text, such as:
#
#Wed Jul 03 03:57:27 UTC 2024
Type=HTTP
clientId=sb-12345abcde|xsuaa_std\!12345abcde
clientSecret=12345abcde
HTML5.DynamicDestination=true
Authentication=OAuth2ClientCredentials
URL.headers.OData.Property=default
Name=ODataDest.
tokenServiceURL=https://myaccount.authentication.sap.hana.ondemand.com/oauth/token
URL=https\://my12345-api.s4hana.ondemand.com/sap/opu/odata/sap/API_BUSINESS_PARTNER/ProxyType=Internet
tokenServiceURLType=Dedicated
URL.headers.Content-Type=application/json
AppgyverEnabled=true
sap.applicationdevelopment.actions.enabled=true
WebIDEEnabled=true

The prompt generator 110 uses the configuration information to query the vector database 104 for related knowledge, and then combines the results from the vector database 104 with the configuration information from the user interface 106 into a prompt. This is accomplished by the prompt generator 110 preparing a similarity query using the user's configuration information.

For example, if the parameters ““Authentication OAuth2ClientCredentials,” are defined in the OData configuration, then the prompt generator 110 may define the query vector by representing the concept “Authentication OAuth2ClientCredentials,” as a vector. This may include passing the parameters through the embedding machine learning model 102. Then the vector database 104 is searched to find vectors similar to the vector representing the concept “Authentication OAuth2ClientCredentials.” The most similar vectors are then used to fetch the most similar entries from the vector database 104.

For example, in table knowledge_base with a column vector storing the vector representations and a column content storing the textual content, the query might look like this:

-- Define the query vector for “Authentication OAuth2ClientCredentials”
DECLARE query_vector VECTOR := (0.1, 0.2, 0.3, ..., 0.9); -
- Example vector values
-- Perform the similarity search
SELECT content
FROM knowledge_base
ORDER BY vector <=> query_vector
LIMIT 10;

### Explanation

DECLARE query_vector: This step defines the vector representation of the concept “Authentication OAuth2ClientCredentials.” The actual vector values would depend on how the concept is encoded.
SELECT content: This part of the query selects the content column from the knowledge_base table.
ORDER BY vector<=>query_vector: This clause orders the results by similarity to the query_vector. The <=> operator represents the similarity measure (e.g., cosine similarity).
LIMIT 10: This limits the results to the top 10 most similar entries.

The above is just an example. The real query may differ according to the specific database schema and vector representation.

As described above, embeddings in the vector database that are similar to the embedding from the prompt generator 110 may be located. In an example embodiment, this may be performed by calculating the cosine correlation coefficient between the embedding vₛ and the embeddings vᵣ of field FIELD1 of every record by the following formula.

$${c}_{s , r} = \frac{{\sum }_{n = 1}^{N} ( {v}_{s , n} \cdot {v}_{r , n} )}{\sqrt{{\sum }_{n = 1}^{N} {( {v}_{s , n} )}^{2}} \cdot \sqrt{{\sum }_{n = 1}^{N} {( {v}_{r , n} )}^{2}}}$$

Where N is the dimension of the embeddings, V_{s,n} is the n-th element Vₛ, and V_{r,n} is the n-th element of Vᵣ.

What counts as “similar” may be defined based on a preset threshold Cₜₕ, and thus record IDs whose c_{s,r} are greater than a threshold Cₜₕ are selected as “similar” embeddings. Then the results corresponding to the similar embeddings, may be retrieved and returned.

The results from the vector database 104 may include relevant domain-specific knowledge, backend service specifications, and examples of OData destination configurations that match the query. For example, the query result could be something like:
1. Content: “OAuth2ClientCredentials is a common authentication method used in enterprise applications. It involves obtaining an access token using client credentials (client ID and client secret) to authenticate API requests.”
   Vector: (0.12, 0.34, 0.56, . . . , 0.78)
2. Content: “To configure OAuth2ClientCredentials in SAP BTP, you need to set the ‘Authentication’ parameter to ‘OAuth2ClientCredentials’ and provide the ‘clientId’ and ‘clientSecret’ in the destination configuration.”
   Vector: (0.11, 0.33, 0.55, . . . , 0.77)
3. Content: “Example OData destination configuration: Type=HTTP Authentication-OAuth2ClientCredentials clientId=your-client-id clientSecret=your-client-secret URL=https://your-odata-service-url This configuration allows secure access to OData services using client credentials.”
Vector: (0.13, 0.35, 0.57, . . . , 0.79)
4. Content: “Backend service specifications for OAuth2ClientCredentials include set ting up an OAuth2 authorization server, defining client credentials, and configuring token endpoints.”
Vector: (0.14, 0.36, 0.58, . . . , 0.80)
5. Content: “In SAP HANA, you can use the OAuth2ClientCredentials authentication method to securely connect to various backend services, ensuring that only authorized clients can access the data.”
Vector: (0.15, 0.37, 0.59, . . . , 0.81)
In total 5 record are returned, with each has content field and vector field.
Content: The textual content retrieved from the vector database that matches the query “Authentication OAuth2ClientCredentials.”
Vector: The vector representation of the content in the database.
Detailed Breakdown of return result:
Domain-Specific Knowledge: The first result provides a general explanation of the OAuth2ClientCredentials authentication method.
Backend Service Specifications: The fourth result details the backend service specifications required for setting up OAuth2ClientCredentials.
Examples of OData Destination Configurations: The third result provides an example configuration for an OData destination using OAuth2ClientCredentials. These results are ordered by their similarity to the query vector, ensuring that the most relevant information is retrieved first.

The prompt generated by the prompt generator 110 includes the configuration information, the results from the vector database 104, and one or more messages instructing the LLM 112 to cause the LLM 112 to check for any discrepancies or misconfigurations in the configuration information and generate recommendations for rectifying any detected discrepancies and/or misconfigurations.

The following is an example prompt in accordance with an example embodiment:
As an expert in SAP BTP destination service, can you please check for any discrepancies and misconfigurations in this OData destination configuration<original OData destination configuration provided by the customer in step 2> please use following knowledge as reference<the retrieved knowledge from the vector database in step 5>

Please provide the detailed steps on how to rectify the discrepancies and misconfigurations and explain the reasons for making those changes. Please return the information in a specific schema, such as a structured JSON format as below

### Example JSON Schema:

```
{
  “steps”: [
    {
      “step”: 1,
      “description”: “Dummy description 1”,
      “action”: “Dummy action 1”,
      “reason”: “Dummy reason 1”
    },
    {
      “step”: 2,
      “description”: “Dummy description 2”,
      “action”: “Dummy action 2”,
      “reason”: “Dummy reason 2”
    },
    {
      “step”: 3,
      “description”: “Dummy description 3”,
      “action”: “Dummy action 3”,
      “reason”: “Dummy reason 3”
    }
  ]
}
```

This JSON schema provides a structured format for detailing the steps to rectify discrepancies and misconfigurations, along with the reasons for each change.

This prompt may then be formatted and sent to the LLM 112 in the form of a Hypertext Transfer Protocol (HTTP) Representational State Transfer (REST) Application Program Interface (API) call.

The LLM 112 generates the recommendations and explanations for the suggested rectifications based on the prompt. The following is an example of such generated recommendations and explanations:

```
{
  “steps”: [
    {
      “step”: 1,
      “description”: “Verify Authentication Method”,
      “action”: “Ensure the ‘Authentication’ parameter is set to ‘OAuth2ClientCredenti
als'.”,
      “reason”: “This is required to use client credentials for authentication.”
    },
    {
      “step”: 2,
      “description”: “Check Client Credentials”,
      “action”: “Verify that ‘clientId’ and ‘clientSecret’ are correctly provided.”,
      “reason”: “These credentials are necessary to obtain an access token.”
    },
    {
      “step”: 3,
      “description”: “Validate Token Service URL”,
      “action”: “Ensure the ‘tokenServiceURL’ is correct and accessible.”,
      “reason”: “This URL is used to obtain the access token.”
    },
    {
      “step”: 4,
      “description”: “Confirm URL Configuration”,
      “action”: “Verify the ‘URL’ parameter points to the correct OData service endpoi
nt.”,
      “reason”: “This is the endpoint that the destination will interact with.”
    },
    {
      “step”: 5,
      “description”: “Check Additional Headers”,
      “action”: “Ensure headers like ‘Content-Type’ and ‘AI-Resource-
Group’ are correctly set.”,
      “reason”: “These headers might be required by the OData service for proper requ
est handling.”
    },
    {
      “step”: 6,
      “description”: “Review Proxy Type”,
      “action”: “Confirm the ‘ProxyType’ is set to ‘Internet’ if accessing an external ser
vice.”,
      “reason”: “This ensures the destination can reach the external service.”
    },
    {
      “step”: 7,
      “description”: “Enable Necessary Features”,
      “action”: “Ensure ‘AppgyverEnabled’, ‘sap.applicationdevelopment.actions.enabl
ed’, and ‘WebIDEEnabled’ are set to ‘true’ if required.”,
      “reason”: “These settings enable the destination for use in various SAP tools.”
    }
  ]
}
```

The LLM 112 passes these recommendations, along with explanations for the suggested rectifications, to the user interface 106, wherein the user can take action based on the recommendations. This action could include, for example, accepting a recommendation of a suggested replacement OData configuration for the OData destination, or a recommendation of suggested modifications to the existing OData configuration for the OData destination.

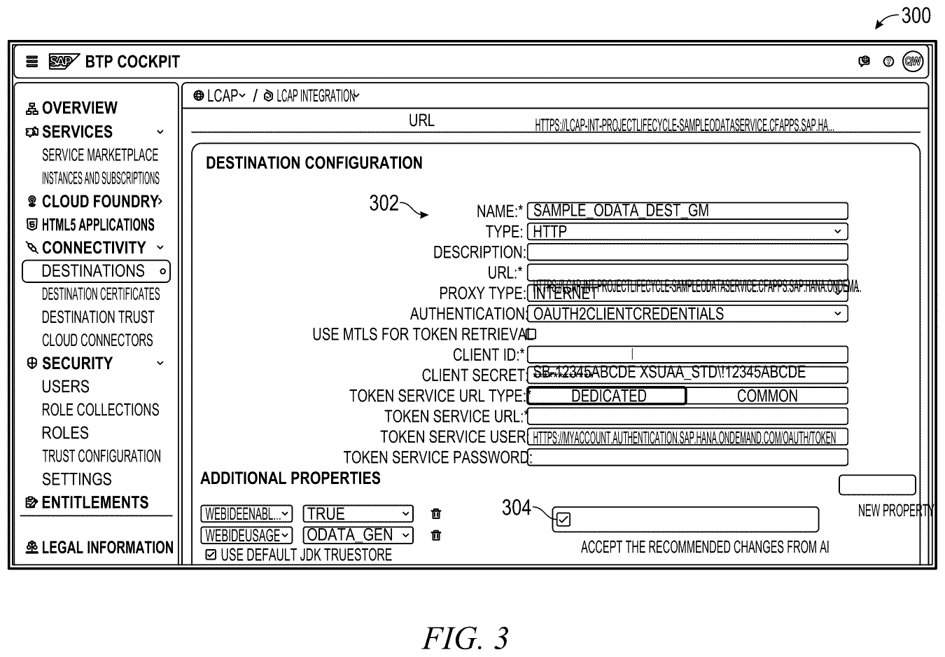

FIG. 3 is a screen capture illustrating a screen 300 of a user interface where a user can accept recommendations from an LLM, in accordance with an example embodiment. Here, a revised OData destination configuration 302 is presented to the user and a checkbox 304 is provided where the user can elect to accept the recommended changes or not.

Once a recommendation is selected and approved, a testing component 114 acts to test the new OData configuration for the OData destination. If any issues arise, a feedback look can be implemented where information about the new issue(s) is passed to the prompt generator 110 to generate a new prompt, to get a new round of checking and recommendation generation. Part of this feedback loop can include using the error log of the test and any change in the user interface as feedback for the next iteration. The system 100 can be continuously improved by updating the vector database 104 with new knowledge and examples based on customer feedback, as well as based on generated successful OData configurations, improving the accuracy and relevance of future queries and recommendations.

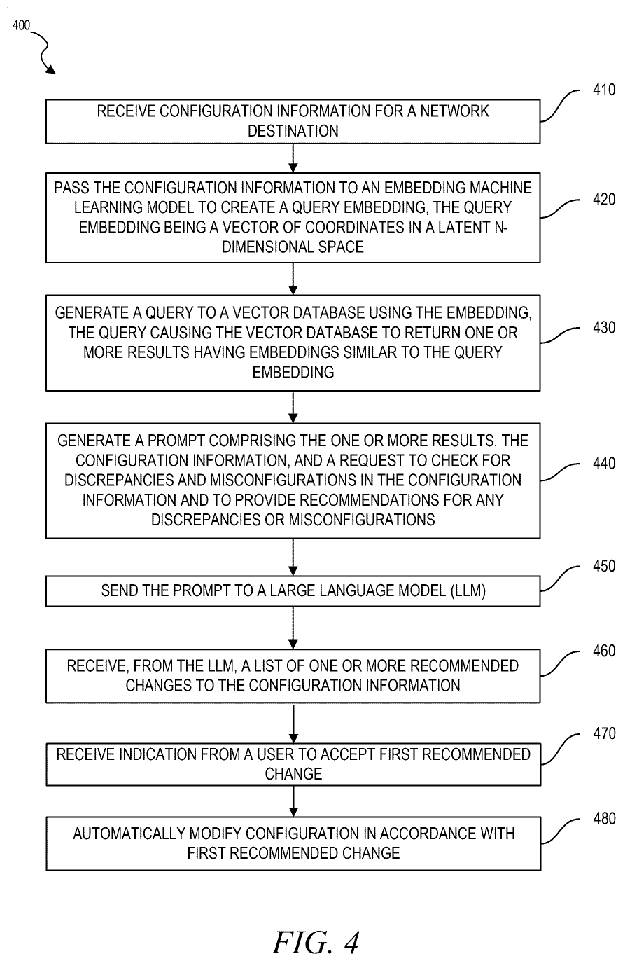

FIG. 4 is a flow diagram illustrating a method 400, in accordance with an example embodiment. The method 400 may be triggered in a number of different ways. In a first example embodiment, the method 400 is triggered upon the receipt of a ticket from a user that indicates that an issue may have occurred with an OData configuration. In another example embodiment, the method 400 is triggered automatically based on detected errors or detected error messages regarding the OData configuration. At operation 410, configuration information for a network destination is received.

At operation 420, the configuration information is passed to an embedding machine learning model to create a query embedding. The query embedding is a vector of coordinates in a latent n-dimensional space.

At operation 430, a query to a vector database is generated using the embedding, the query causing the vector database to return one or more results having embeddings similar to the query embedding.

At operation 440, a prompt is generated, including the one or more results, the configuration information, and a request to check for discrepancies and misconfigurations in the configuration information and to provide recommendations for any discrepancies or misconfigurations.

At operation 450, the prompt is sent to an LLM.

At operation 460, a list of one or more recommended changes to the configuration information is received from the LLM.

At operation 470, an indication is received from a user to accept a first recommended change in the list of one or more recommended changes.

At operation 480, in response to the receiving of the indication, the configuration information is automatically modified in accordance with the first recommended change.

In view of the disclosure above, various examples are set forth below. It should be noted that one or more features of an example, taken in isolation or combination, should be considered within the disclosure of this application.

Example 1 is a system comprising: at least one hardware processor; a non-transitory computer-readable medium storing instructions that, when executed by the at least one hardware processor, cause the at least one hardware processor to perform operations comprising: receiving configuration information for a network destination; passing the configuration information to an embedding machine learning model to create a query embedding, the query embedding being a vector of coordinates in a latent n-dimensional space; generating a query to a vector database using the embedding, the query causing the vector database to return one or more results having embeddings similar to the query embedding; generating a prompt comprising the one or more results, the configuration information, and a request to check for discrepancies and misconfigurations in the configuration information and to provide recommendations for any discrepancies or misconfigurations; sending the prompt to a Large Language Model (LLM); and receiving, from the LLM, a list of one or more recommended changes to the configuration information.

In Example 2, the subject matter of Example 1 comprises, wherein the network destination is an Open Data Protocol (OData) destination.

In Example 3, the subject matter of Examples 1-2 comprises, wherein the embedding machine learning model is part of the LLM.

In Example 4, the subject matter of Examples 1-3 comprises, wherein the sending the prompt to the LLM is performed using a Representational State Transfer (REST) communication.

In Example 5, the subject matter of Examples 1˜4 comprises, wherein the embeddings in the vector database comprise embeddings formed by passing domain knowledge information through the embedding machine learning model.

In Example 6, the subject matter of Examples 1-5 comprises, wherein the one or more results are ordered based on similarity of their corresponding embedding(s) to the query embedding.

In Example 7, the subject matter of Examples 1-6 comprises, wherein the operations further comprise: receiving an indication from a user to accept a first recommended change in the list of one or more recommended changes; and in response to the receiving of the indication, automatically modifying the configuration information in accordance with the first recommended change.

In Example 8, the subject matter of Examples 1-7 comprises, wherein the knowledge based further comprises embeddings of log files regarding users.

In Example 9, the subject matter of Examples 1-8 comprises, wherein the operations are triggered based on automatic detection of an error in the configuration information.

In Example 10, the subject matter of Examples 1-9 comprises, wherein the operations further comprise: modifying the configuration information based on at least one of the one or more recommended changes; testing the modified configuration information; in response to the modified configuration information failing the testing: generating a new prompt comprising the one or more results, the configuration information, an error log of the testing, the at least one of the one or more recommended changes, and the request to check for discrepancies; sending the new prompt to the LLM; and receiving, from the LLM, a new list of one or more recommended changes to the configuration information.

Example 11 is a method comprising: receiving configuration information for a network destination; passing the configuration information to an embedding machine learning model to create a query embedding, the query embedding being a vector of coordinates in a latent n-dimensional space; generating a query to a vector database using the embedding, the query causing the vector database to return one or more results having embeddings similar to the query embedding; generating a prompt comprising the one or more results, the configuration information, and a request to check for discrepancies and misconfigurations in the configuration information and to provide recommendations for any discrepancies or misconfigurations; sending the prompt to a Large Language Model (LLM); and receiving, from the LLM, a list of one or more recommended changes to the configuration information.

In Example 12, the subject matter of Example 11 comprises, wherein the network destination is an Open Data Protocol (OData) destination.

In Example 13, the subject matter of Examples 11-12 comprises, wherein the embedding machine learning model is part of the LLM.

In Example 14, the subject matter of Examples 11-13 comprises, wherein the sending the prompt to the LLM is performed using a Representational State Transfer (REST) communication.

In Example 15, the subject matter of Examples 11-14 comprises, wherein the embeddings in the vector database comprise embeddings formed by passing domain knowledge information through the embedding machine learning model.

In Example 16, the subject matter of Examples 11-15 comprises, wherein the one or more results are ordered based on similarity of their corresponding embedding(s) to the query embedding.

In Example 17, the subject matter of Examples 11-16 comprises, receiving an indication from a user to accept a first recommended change in the list of one or more recommended changes; and in response to the receiving of the indication, automatically modifying the configuration information in accordance with the first recommended change.

Example 18 is a non-transitory machine-readable medium storing instructions which, when executed by one or more processors, cause the one or more processors to perform operations comprising: receiving configuration information for a network destination; passing the configuration information to an embedding machine learning model to create a query embedding, the query embedding being a vector of coordinates in a latent n-dimensional space; generating a query to a vector database using the embedding, the query causing the vector database to return one or more results having embeddings similar to the query embedding; generating a prompt comprising the one or more results, the configuration information, and a request to check for discrepancies and misconfigurations in the configuration information and to provide recommendations for any discrepancies or misconfigurations; sending the prompt to a Large Language Model (LLM); and receiving, from the LLM, a list of one or more recommended changes to the configuration information.

In Example 19, the subject matter of Example 18 comprises, wherein the network destination is an Open Data Protocol (OData) destination.

In Example 20, the subject matter of Examples 18-19 comprises, wherein the embedding machine learning model is part of the LLM.

Example 21 is at least one machine-readable medium comprising instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

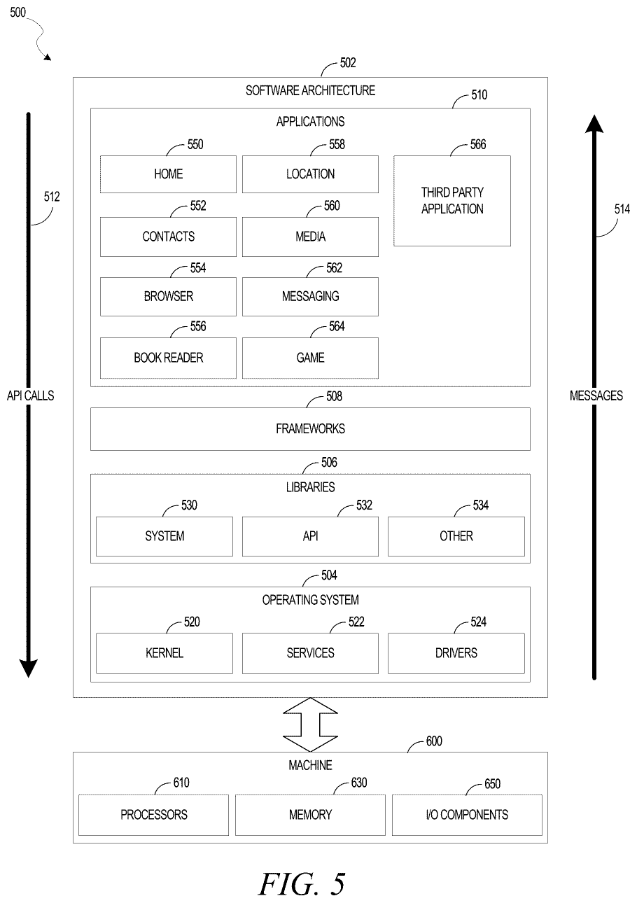

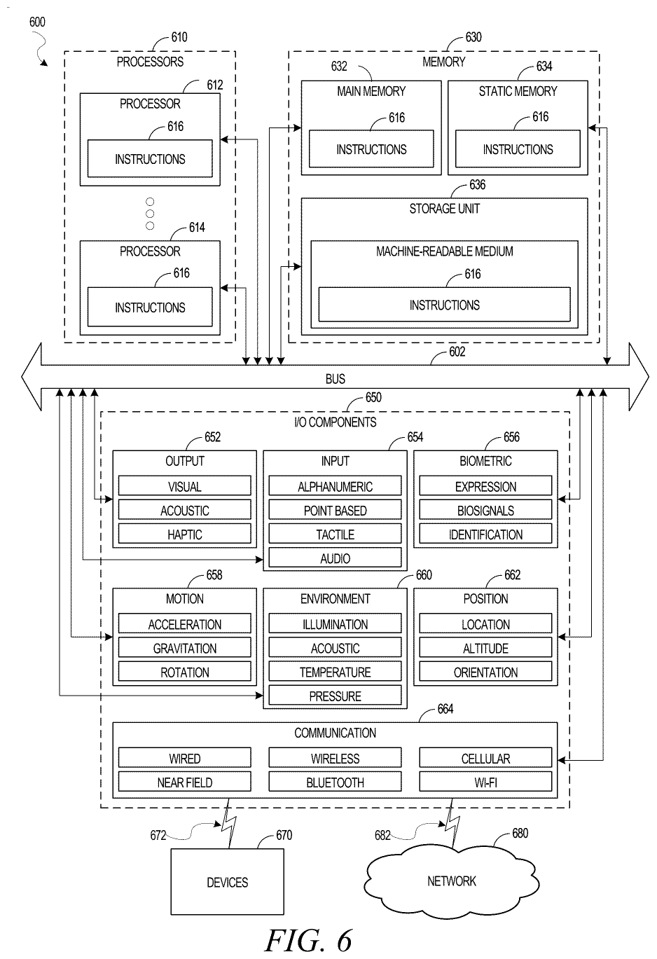

FIG. 5 is a block diagram 500 illustrating a software architecture 502, which can be installed on any one or more of the devices described above. FIG. 5 is merely a non-limiting example of a software architecture, and it will be appreciated that many other architectures can be implemented to facilitate the functionality described herein. In various embodiments, the software architecture 502 is implemented by hardware such as a machine 600 of FIG. 6 that comprises processors 610, memory 630, and input/output (I/O) components 650. In this example architecture, the software architecture 502 can be conceptualized as a stack of layers where each layer may provide a particular functionality. For example, the software architecture 502 comprises layers such as an operating system 504, libraries 506, frameworks 508, and applications 510. Operationally, the applications 510 invoke API calls 512 through the software stack and receive messages 514 in response to the API calls 512, consistent with some embodiments.

In various implementations, the operating system 504 manages hardware resources and provides common services. The operating system 504 comprises, for example, a kernel 520, services 522, and drivers 524. The kernel 520 acts as an abstraction layer between the hardware and the other software layers, consistent with some embodiments. For example, the kernel 520 provides memory management, processor management (e.g., scheduling), component management, networking, and security settings, among other functionalities. The services 522 can provide other common services for the other software layers. The drivers 524 are responsible for controlling or interfacing with the underlying hardware, according to some embodiments. For instance, the drivers 524 can comprise display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 506 provide a low-level common infrastructure utilized by the applications 510. The libraries 506 can comprise system libraries 530 (e.g., C standard library) that can provide functions such as memory allocation functions, string manipulation functions, mathematic functions, and the like. In addition, the libraries 506 can comprise API libraries 532 such as media libraries (e.g., libraries to support presentation and manipulation of various media formats such as Moving Picture Experts Group-4 [MPEG4], Advanced Video Coding [H.264 or AVC], Moving Picture Experts Group Layer-3 [MP3], Advanced Audio Coding [AAC], Adaptive Multi-Rate [AMR] audio codec, Joint Photographic Experts Group [JPEG or JPG], or Portable Network Graphics [PNG]), graphics libraries (e.g., an OpenGL framework used to render in two dimensions [2D] and three dimensions [3D] in a graphic context on a display), database libraries (e.g., SQLite to provide various relational database functions), web libraries (e.g., WebKit to provide web browsing functionality), and the like. The libraries 506 can also comprise a wide variety of other libraries 534 to provide many other APIs to the applications 510.

The frameworks 508 provide a high-level common infrastructure that can be utilized by the applications 510, according to some embodiments. For example, the frameworks 508 provide various GUI functions, high-level resource management, high-level location services, and so forth. The frameworks 508 can provide a broad spectrum of other APIs that can be utilized by the applications 510, some of which may be specific to a particular operating system 504 or platform.

In an example embodiment, the applications 510 comprise a home application 550, a contacts application 552, a browser application 554, a book reader application 556, a location application 558, a media application 560, a messaging application 562, a game application 564, and a broad assortment of other applications, such as a third-party application 566. According to some embodiments, the applications 510 are programs that execute functions defined in the programs. Various programming languages can be employed to create one or more of the applications 510, structured in a variety of manners, such as object-oriented programming languages (e.g., Objective-C, Java, or C++) or procedural programming languages (e.g., C or assembly language). In a specific example, the third-party application 566 (e.g., an application developed using the ANDROID™ or IOS™ software development kit (SDK) by an entity other than the vendor of the platform) may be mobile software running on a mobile operating system such as IOS™, ANDROID™, WINDOWS® Phone, or another mobile operating system. In this example, the third-party application 566 can invoke the API calls 512 provided by the operating system 504 to facilitate functionality described herein.

FIG. 6 illustrates a diagrammatic representation of a machine 600 in the form of a computer system within which a set of instructions may be executed for causing the machine 600 to perform any one or more of the methodologies discussed herein, according to an example embodiment. Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein may be executed. For example, the instructions 616 may cause the machine 600 to execute the method 400 of FIG. 4. Additionally, or alternatively, the instructions 616 may implement FIGS. 1-4 and so forth. The instructions 616 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to comprise a collection of machines 600 that individually or jointly execute the instructions 616 to perform any one or more of the methodologies discussed herein.

The machine 600 may comprise processors 610, memory 630, and I/O components 650, which may be configured to communicate with each other such as via a bus 602. In an example embodiment, the processors 610 (e.g., a central processing unit [CPU], a reduced instruction set computing [RISC] processor, a complex instruction set computing [CISC] processor, a graphics processing unit [GPU], a digital signal processor [DSP], an application-specific integrated circuit [ASIC], a radio-frequency integrated circuit [RFIC], another processor, or any suitable combination thereof) may comprise, for example, a processor 612 and a processor 614 that may execute the instructions 616. The term “processor” is intended to comprise multi-core processors that may comprise two or more independent processors (sometimes referred to as “cores”) that may execute instructions 616 contemporaneously. Although FIG. 6 shows multiple processors 610, the machine 600 may comprise a single processor 612 with a single core, a single processor 612 with multiple cores (e.g., a multi-core processor 612), multiple processors 612, 614 with a single core, multiple processors 612, 614 with multiple cores, or any combination thereof.

The memory 630 may comprise a main memory 632, a static memory 634, and a storage unit 636, each accessible to the processors 610 such as via the bus 602. The main memory 632, the static memory 634, and the storage unit 636 store the instructions 616 embodying any one or more of the methodologies or functions described herein. The instructions 616 may also reside, completely or partially, within the main memory 632, within the static memory 634, within the storage unit 636, within at least one of the processors 610 (e.g., within the processor's cache memory), or any suitable combination thereof, during execution thereof by the machine 600.

The I/O components 650 may comprise a wide variety of components to receive input, provide output, produce output, transmit information, exchange information, capture measurements, and so on. The specific I/O components 650 that are comprised in a particular machine will depend on the type of machine. For example, portable machines such as mobile phones will likely comprise a touch input device or other such input mechanisms, while a headless server machine will likely not comprise such a touch input device. It will be appreciated that the I/O components 650 may comprise many other components that are not shown in FIG. 6. The I/O components 650 are grouped according to functionality merely for simplifying the following discussion, and the grouping is in no way limiting. In various example embodiments, the I/O components 650 may comprise output components 652 and input components 654. The output components 652 may comprise visual components (e.g., a display such as a plasma display panel [PDP], a light-emitting diode [LED] display, a liquid crystal display [LCD], a projector, or a cathode ray tube [CRT]), acoustic components (e.g., speakers), haptic components (e.g., a vibratory motor, resistance mechanisms), other signal generators, and so forth. The input components 654 may comprise alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 650 may comprise biometric components 656, motion components 658, environmental components 660, or position components 662, among a wide array of other components. For example, the biometric components 656 may comprise components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram-based identification), and the like. The motion components 658 may comprise acceleration sensor components (e.g., accelerometer), gravitation sensor components, rotation sensor components (e.g., gyroscope), and so forth. The environmental components 660 may comprise, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 662 may comprise location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may comprise communication components 664 operable to couple the machine 600 to a network 680 or devices 670 via a coupling 682 and a coupling 672, respectively. For example, the communication components 664 may comprise a network interface component or another suitable device to interface with the network 680. In further examples, the communication components 664 may comprise wired communication components, wireless communication components, cellular communication components, near field communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., coupled via a USB).

Moreover, the communication components 664 may detect identifiers or comprise components operable to detect identifiers. For example, the communication components 664 may comprise radio-frequency identification (RFID) tag reader components, NFC smart tag detection components, optical reader components (e.g., an optical sensor to detect one-dimensional bar codes such as Universal Product Code [UPC] bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NFC beacon signal that may indicate a particular location, and so forth.

The various memories (e.g., 630, 632, 634, and/or memory of the processor[s] 610) and/or the storage unit 636 may store one or more sets of instructions 616 and data structures (e.g., software) embodying or utilized by any one or more of the methodologies or functions described herein. These instructions (e.g., the instructions 616), when executed by the processor(s) 610, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to comprise, but not be limited to, solid-state memories, and optical and magnetic media, comprising memory internal or external to processors. Specific examples of machine-storage media, computer-storage media, and/or device-storage media comprise non-volatile memory, comprising by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 680 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 680 or a portion of the network 680 may comprise a wireless or cellular network, and the coupling 682 may be a Code Division Multiple Access (CDMA) connection, a Global System for Mobile communications (GSM) connection, or another type of cellular or wireless coupling. In this example, the coupling 682 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) comprising 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 616 may be transmitted or received over the network 680 using a transmission medium via a network interface device (e.g., a network interface component comprised in the communication components 664) and utilizing any one of a number of well-known transfer protocols (e.g., HTTP). Similarly, the instructions 616 may be transmitted or received using a transmission medium via the coupling 672 (e.g., a peer-to-peer coupling) to the devices 670. The terms “transmission medium” and “signal medium” mean the same thing and may be used interchangeably in this disclosure. The terms “transmission medium” and “signal medium” shall be taken to comprise any intangible medium that is capable of storing, encoding, or carrying the instructions 616 for execution by the machine 600, and comprise digital or analog communications signals or other intangible media to facilitate communication of such software. Hence, the terms “transmission medium” and “signal medium” shall be taken to comprise any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to comprise both machine-storage media and transmission media. Thus, the terms comprise both storage devices/media and carrier waves/modulated data signals.

What is claimed is:

1. A system comprising:
at least one hardware processor;
a non-transitory computer-readable medium storing instructions that, when executed by the at least one hardware processor, cause the at least one hardware processor to perform operations comprising:
receiving configuration information for a network destination;
passing the configuration information to an embedding machine learning model to create a query embedding, the query embedding being a vector of coordinates in a latent n-dimensional space;
generating a query to a vector database using the embedding, the query causing the vector database to return one or more results having embeddings similar to the query embedding;
generating a prompt comprising the one or more results, the configuration information, and a request to check for discrepancies and misconfigurations in the configuration information and to provide recommendations for any discrepancies or misconfigurations;
sending the prompt to a Large Language Model (LLM); and
receiving, from the LLM, a list of one or more recommended changes to the configuration information.

2. The system of claim 1, wherein the network destination is an Open Data Protocol (OData) destination.

3. The system of claim 1, wherein the embedding machine learning model is part of the LLM.

4. The system of claim 1, wherein the sending the prompt to the LLM is performed using a Representational State Transfer (REST) communication.

5. The system of claim 1, wherein the embeddings in the vector database comprise embeddings formed by passing domain knowledge information through the embedding machine learning model.

6. The system of claim 1, wherein the one or more results are ordered based on similarity of their corresponding embedding(s) to the query embedding.

7. The system of claim 1, wherein the operations further comprise:
receiving an indication from a user to accept a first recommended change in the list of one or more recommended changes; and
in response to the receiving of the indication, automatically modifying the configuration information in accordance with the first recommended change.

8. The system of claim 1, wherein the knowledge based further comprises embeddings of log files regarding users.

9. The system of claim 1, wherein the operations are triggered based on automatic detection of an error in the configuration information.

10. The system of claim 1, wherein the operations further comprise:
modifying the configuration information based on at least one of the one or more recommended changes;
testing the modified configuration information;
in response to the modified configuration information failing the testing:
generating a new prompt comprising the one or more results, the configuration information, an error log of the testing, the at least one of the one or more recommended changes, and the request to check for discrepancies;
sending the new prompt to the LLM; and
receiving, from the LLM, a new list of one or more recommended changes to the configuration information.

11. A method comprising:
receiving configuration information for a network destination;
passing the configuration information to an embedding machine learning model to create a query embedding, the query embedding being a vector of coordinates in a latent n-dimensional space;
generating a query to a vector database using the embedding, the query causing the vector database to return one or more results having embeddings similar to the query embedding;
generating a prompt comprising the one or more results, the configuration information, and a request to check for discrepancies and misconfigurations in the configuration information and to provide recommendations for any discrepancies or misconfigurations;
sending the prompt to a Large Language Model (LLM); and
receiving, from the LLM, a list of one or more recommended changes to the configuration information.

12. The method of claim 11, wherein the network destination is an Open Data Protocol (OData) destination.

13. The method of claim 11, wherein the embedding machine learning model is part of the LLM.

14. The method of claim 11, wherein the sending the prompt to the LLM is performed using a Representational State Transfer (REST) communication.

15. The method of claim 11, wherein the embeddings in the vector database comprise embeddings formed by passing domain knowledge information through the embedding machine learning model.

16. The method of claim 11, wherein the one or more results are ordered based on similarity of their corresponding embedding(s) to the query embedding.

17. The method of claim 11, further comprising:
receiving an indication from a user to accept a first recommended change in the list of one or more recommended changes; and
in response to the receiving of the indication, automatically modifying the configuration information in accordance with the first recommended change.

18. A non-transitory machine-readable medium storing instructions which, when executed by one or more processors, cause the one or more processors to perform operations comprising:
receiving configuration information for a network destination;
passing the configuration information to an embedding machine learning model to create a query embedding, the query embedding being a vector of coordinates in a latent n-dimensional space;
generating a query to a vector database using the embedding, the query causing the vector database to return one or more results having embeddings similar to the query embedding;
generating a prompt comprising the one or more results, the configuration information, and a request to check for discrepancies and misconfigurations in the configuration information and to provide recommendations for any discrepancies or misconfigurations;
sending the prompt to a Large Language Model (LLM); and
receiving, from the LLM, a list of one or more recommended changes to the configuration information.

19. The non-transitory machine-readable medium of claim 18, wherein the network destination is an Open Data Protocol (OData) destination.

20. The non-transitory machine-readable medium of claim 18, wherein the embedding machine learning model is part of the LLM.
